(19) United States
(12) Patent Application Publication
(10) Pub. No.: US 2023/0093500 A1
(43) Pub. Date: Mar. 23, 2023

(54) ULTRATHIN EYEGLASSES AND CASE

(71) Applicant: THINOPTICS, INC., Palo Alto, CA (US)

(72) Inventor: Gad PONTE, Palo Alto, CA (US)

(21) Appl. No.: 17/905,034

(22) PCT Filed: Feb. 25, 2021
(86) PCT No.: PCT/US2021/019631

§ 371 Date: Aug. 25, 2022

Related U.S. Application Data
(60) Provisional application No. 62/981,450, filed on Feb. 25, 2020.

(51) Int. Cl. G02C 5/00; A45C 11/04; G02C 5/22; G02C 5/14; G02C 5/16

(52) U.S. Cl. CPC G02C 5/008; A45C 11/04; G02C 5/22; G02C 5/143; G02C 5/16; A45C 2011/002

(57) ABSTRACT

Embodiments of ultrathin eyeglasses are provided. The eyeglasses comprise a frame and temple pieces extending from the frame. The frame and temple pieces are configured to be directly connected using a bearing or a pin, without the need for a separately attached hinge piece. The temple pieces are configured to sit flat against the frame. An eyeglasses case is also provided. The case has a thin profile and is configured to be attached to a smartphone. The connection between the case and the smartphone allows relative rotation between the case and the smartphone.

### CROSS-REFERENCE TO RELATED APPLICATIONS

This application claims the benefit of U.S. Provisional Patent Application No. 62/981,450, filed Feb. 25, 2020, the entire disclosure of which is herein incorporated by reference.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

This application relates to the field of eyewear.

### BACKGROUND

Eyewear and in particular, glasses that are used episodically (e.g., sun glasses, reading glasses and safety glasses), benefit from a thin design, allowing convenient carrying of the glasses. Such glasses can also be used with a compact, convenient carrying case that attaches to key chains, smart phones, clothing or can be placed in pockets or purses. The present application provides a convenient way to create ultrathin glasses that can be inserted folded into a carrying case not much bigger than the thickness of the eyeglasses frame.

### SUMMARY OF THE DISCLOSURE

In a first aspect, embodiments of eyeglasses are provided. The eyeglasses comprise a frame comprising a first lens and a second lens connected by a nosebridge; a first temple piece extending from a first end of the frame and configured to fold down, the first temple piece configured to fold against the frame in a folded configuration; a second temple piece extending from a second end of the frame, the second temple piece configured to fold flat against the frame in a folded configuration, wherein the frame is directly connected to the first and second temple pieces without a separately attached hinge.

In some embodiments, at least one of the first lens and the second lens is an aspherical lens comprising high index material. Additional lens material can be added to an edge of the lens to extend the aspherical lens to the frame.

In some embodiments, the frame comprises a rigid material.

The thickness of the eyeglasses in the folded configuration can be about 2.6 mm.

In some embodiments, at least one of the first lens and the second lens comprises a high index, aspherical lens.

The frame can comprise polycarbonate.

In some embodiments, at least one of the first temple piece and the second temple piece comprises a metal. At least one of the first temple piece and the second temple piece can comprise nitinol.

In some embodiments, at least one of the first temple piece and the second temple piece is plated or painted to match a color or design of the frame.

The frame can comprise a color or design.

In some embodiments, the eyeglasses comprises a loop formed at an end of at least one of the first temple piece and the second temple piece and a pocket formed on an edge of the frame, the loop configured to be inserted into the pocket. A pin can be inserted through the pocket and the loop, the loop configured to rotate about the pin. In some embodiments, the eyeglasses comprise a bearing configured to be inserted within the loop.

The first and second temple pieces can be configured to fold flat against the frame in an unbiased configuration.

In some embodiments, the first and second temple piece comprise a tab comprising an aperture configured to align with an aperture at an end of the frame.

The eyeglasses can comprise a first tab with a first aperture and a second tab with a second aperture, the first and second apertures configured to align with an aperture at an end of the frame.

In some embodiments, an eyewear system comprising the eyeglasses described herein and a case comprising a thickness of less than or equal to about 3.5 mm is provided.

In another aspect, a method of manufacturing eyeglasses is provided. The method comprises providing a frame comprising a first lens and a second lens connected by a nosebridge; providing a first temple piece extending from a first end of the frame and configured to fold down, the first temple piece configured to fold against the frame in a folded configuration; providing a second temple piece extending from a second end of the frame, the second temple piece configured to fold against the frame in a folded configuration; inserting a first pin within an aperture in the first end of the frame and an opening in the first temple piece, joining the first temple piece to the frame; and inserting a second pin within an aperture in the second end of the frame and an opening in the second temple piece, joining the second temple piece to the frame, wherein joining the first temple piece and the second temple piece to the frame does not comprise using a separate hinge component.

The method can comprise UV printing the frame to apply a color or pattern.

In some embodiments, the method comprises plating at least one of the first and second temple pieces to apply a color or design.

The method can comprise applying soft touch paint to at least one of the first and second temple pieces to apply a color or design.

In some embodiments, at least one of the lenses is an aspherical lens comprising a high index material.

Providing the frame can comprise adding additional material to an edge of the aspherical lens to extend it to reach the frame. In some embodiments, providing the frame comprises adding additional material to an edge of the aspherical lens to thicken the edge of the aspherical lens.

In yet another aspect, embodiments of an eyeglasses case are provided. The case comprises a back wall; a front sleeve extending from the back wall, the front sleeve and back wall defining a pocket configured to receive eyeglasses; and a connector configured to attach the case to a smartphone, wherein the connector is configured to allow connection between the case in the smartphone in a first configuration comprising a first angle between the case and the smartphone and a second configuration comprising a second angle between the case and the smartphone, wherein the first angle is different from the second angle.

In some embodiments, the connector comprises a magnetic connector.

The connector can comprise a depression comprising a magnetic component, the depression configured to receive a magnetic component attached to the smartphone.

In some embodiments, the magnetic component and/or the depression comprises a square shape.

The first angle and the second angle can be generally perpendicular.

In some embodiments, the connector comprises a plate configured to be attached to the smartphone.

The case can comprise a recessed area shaped to receive the plate.

In some embodiments, the connector comprises a magnet configured to be attached to the smartphone.

In another aspect, embodiments of an eyeglasses case are provided. The case comprises a pocket configured to receive eyeglasses; and a connector configured to attach the case to a smartphone, wherein the connector is configured to allow connection between the case in the smartphone in a first configuration comprising a first angle between the case and the smartphone and a second configuration comprising a second angle between the case and the smartphone, wherein the first angle is different from the second angle.

The connector can comprise a depression comprising a magnetic component, the depression configured to receive a magnetic component attached to the smartphone.

In some embodiments, the magnetic component and/or the depression comprises a square shape.

The first angle and the second angle can be generally perpendicular.

In some embodiments, the connector comprises a plate configured to be attached to the smartphone.

The case can comprise a recessed area shaped to receive the plate.

In some embodiments, the connector comprises a magnet configured to be attached to the smartphone.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIGS. 1A-1E show various views of an embodiment of eyeglasses.

FIGS. 2A-2B show various configurations of an embodiment of an eyeglasses case attached to a smartphone.

FIGS. 3A-3F show various views of an embodiment of an eyeglasses case configured to be attached to a smartphone.

FIG. 4 shows an embodiment of eyeglasses being inserted into an embodiment of an eyeglasses case.

FIGS. 5A and 5B show an embodiment of a connection between eyeglasses and an eyeglasses case.

### DETAILED DESCRIPTION

Embodiments of ultrathin eyeglasses are provided herein. The eyeglasses comprise a thin frame comprising two lenses connected by a nosebridge. A temple piece extends from each end of the frame. The temple pieces can be configured to fold flat or near flat against the frame and lenses such that there is little or no space between the temple piece and the frame in the folded configuration. The temple piece can be directly connected to the frame, without the use of an overmolded hinge. The frame can comprise a plastic or polymer material and can be entirely molded from such a material. This design can allow for a frame with a very thin profile, (e.g., less than 3.5 mm, enabling users to easily carry the glasses on a phone, in a purse, in a pocket, etc.

Currently available thin profile glasses generally do not comprise traditional temple pieces that are configured to fold flat or near flat against the frame. Such temple pieces can both provide stability to the user as well as provide a desired aesthetic affect. Additionally, currently available thin profile glasses generally do not comprise a temple piece that is directly connected to the frame without the use of separately attached hinge (e.g., an overmolded hinge). The direction connection between the frame and the temple piece greatly increases ease of manufacturing and durability of the glasses.

The enhanced stability enables the glasses to be worn during performance of numerous activities, not only limited to reading. The desired aesthetic affect can be due to the temple pieces resembling traditional, in-style temple piece design. Paper Glass, manufactured by Masahiro Sawada, utilizes curved temple pieces configured to fold above, instead of against, the lenses. While this produces a thin pair of glasses, the glasses do not have a traditional design, and may not appeal to as many users for that reason.

The eyeglasses disclosed herein are also able to be folded into the thin configuration, with the temple pieces flat against the frame, without any external biasing force placed on the temple pieces (i.e., without manipulation by a case or other apparatus).

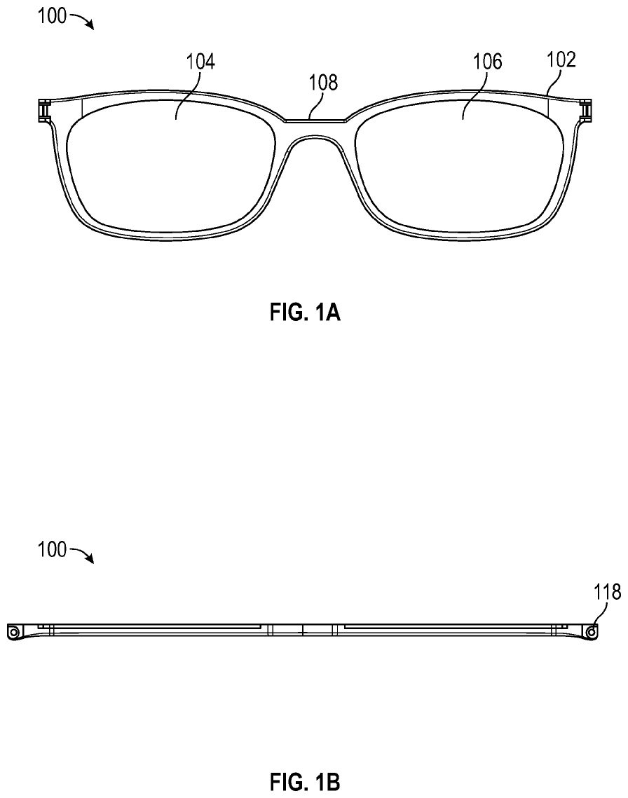

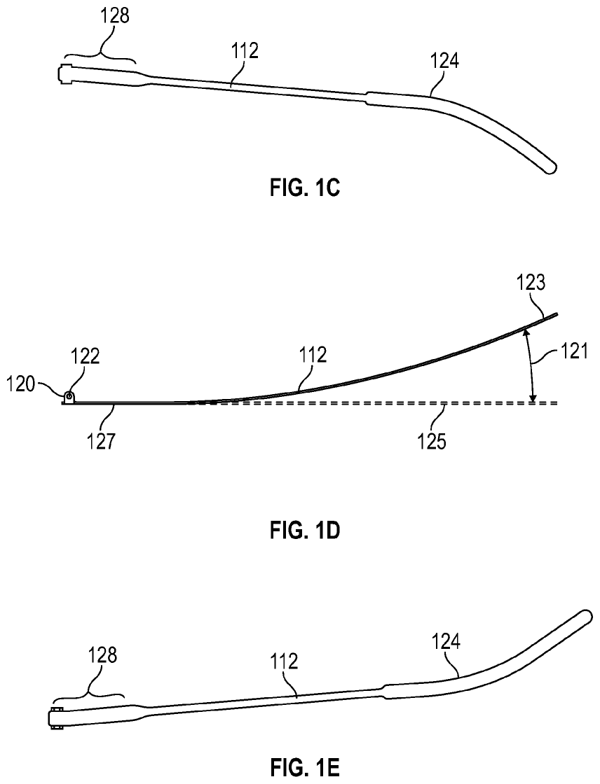

FIG. 1A shows an embodiment of a pair of eyeglasses 100. The eyeglasses 100 comprises a frame 102 holding a first lens 104 and a second lens 106. A nosebridge 108 connects the portion of the frame 102 holding the first lens 104 to the portion of the frame holding the second lens 106. A first temple piece extends from a first side of the frame 102, next to the first lens 104. A second temple piece 112 (FIGS. 1C-1E) extends from a second side of the frame 102, next to the second lens 106. The first temple piece is connected to the frame 102 at hinge 114. The second temple piece 112 is connected to the frame 102 at hinge 116. As noted previously, the frame 102 is directly connected to the temple pieces via a pin, without using any additional hinge components.

In some embodiments, the frame comprises a polymer, such as polycarbonate. Other materials are also possible (e.g., Acetate, TR90, ULTEM, etc.). Such a material provides an aesthetic advantage as it can be used to create in-style designs, resembling glasses made of more traditional materials and still maintain a very thin profile. Such a material also provides the advantage of being able to be colored or patterned in a variety of styles. The color or pattern can be added using UV printing, which can provide the advantage of allowing a wide variety of styles to be produced economically. In some embodiments, a hardcoating process is used to make the lenses scratch resistant. Other coatings are also possible. For example, an anti-reflective coating and anti finger print coating can be applied as well. The frame can comprise a rigid material (e.g., the frame cannot be bent).

The lenses can comprise polycarbonate. In some embodiments, the lenses 104, 106 can be formed integrally with the frame 102. For example, the lenses and the frame can be molded as one solid piece (e.g., one solid piece of polycarbonate). In some embodiments, the lenses 104, 106 can be formed separately from the frame 102 and later attached to the frame.

In some embodiments, the nosebridge 108 comprises the same material as the rest of the frame (e.g., polycarbonate). In some embodiments, the bridge 108 can comprise a different material (e.g., nitinol). A combination of the bridge 108 and a portion 122 of the frame can be used to provide a comfortable fit on the nose without the use of any nose pads. In some embodiments, separate nose pads can be used to increase the friction with the nose on the edge of the frame that is in contact with the nose. Materials such as low durometer elastomers, grit embedded strip, micro texture on the frame can be used to increase the friction between the glasses and the nose. In some embodiments, micro texture is added by molding small serrations directly into the frame.

The glasses can be designed in a way that doesn't require a separate hinge component. The temples can be assembled directly to frame by using a component, such as a pin, that connects the frame and the temples. This direct connection allows the temples to fold flat directly towards the frame and keeps the overall glasses thickness less than 3.5 mm with wasted real estate minimized.

In some embodiments, the temple pieces comprise a metal (e.g., nitinol). The temple pieces can be configured to fold flat against the frame. In some embodiments, the temple pieces are configured to fold near flat against the frame.

The temple piece can be attached to the frame 102 using a pin 118 (FIG. 1B). Other configurations are also possible (e.g., press fit pin).

FIGS. 1C-1E show front, top, and back views, respectively of an embodiment of a temple piece. The temple piece comprises a connecting portion 128 that is positioned closest to the hinge. The connecting portion 128 can have a greater surface area than other portions of the temple piece. This larger surface area can help distribute some of the pressure exerted near the hinge between the temple piece and the glasses. The first portion comprises a connection point 120 with an aperture 122 configured to be connected to the frame 102, forming a hinge. The connection point 120 is best shown in the top view of FIG. 1D. The connection point can comprise a thin tab that extends from a side of the temple piece at an end of the temple piece closest to the frame.

A thin tab can extend from either side of the temple piece at the end of the temple piece. Each tab can comprise an aperture 122. In some embodiments, the tabs are integrally formed with the temple pieces. They can also be separately formed and attached. The apertures 122 can be configured to align with a corresponding aperture on the frame.

In some embodiments, the temple pieces 114, 116 comprise a temple tip 124, shown in FIGS. 1C and 1E. The temple tip 124 can comprise a larger surface area than other portions of the temple piece. This larger surface area can help distribute some of the pressure exerted by the temple piece on a user's head. The temple tip 124 can comprise a same material as the temple pieces 114, 116. In some embodiments, the temple tip 124 comprises a different material from the temple pieces 114, 116. For example, the temple tips can comprise low durometer elastomers or thermos plastics. Materials like silicone or soft touch paint can be used to increase friction between the temple tips and the head and to match the color of the temple tip to the temple piece 114, 116.

As best shown in the top view of FIG. 1D, an end of the temple piece may be curved in an inward direction, toward the head of the user when the glasses are being worn. An angle 121 between the free end 123 of the temple piece and a line 125 extending from the connecting end 127 of the temple piece can be about 15-30°, or about 17-27°, or about 20-24°, or about 21-23°, or about 22°.

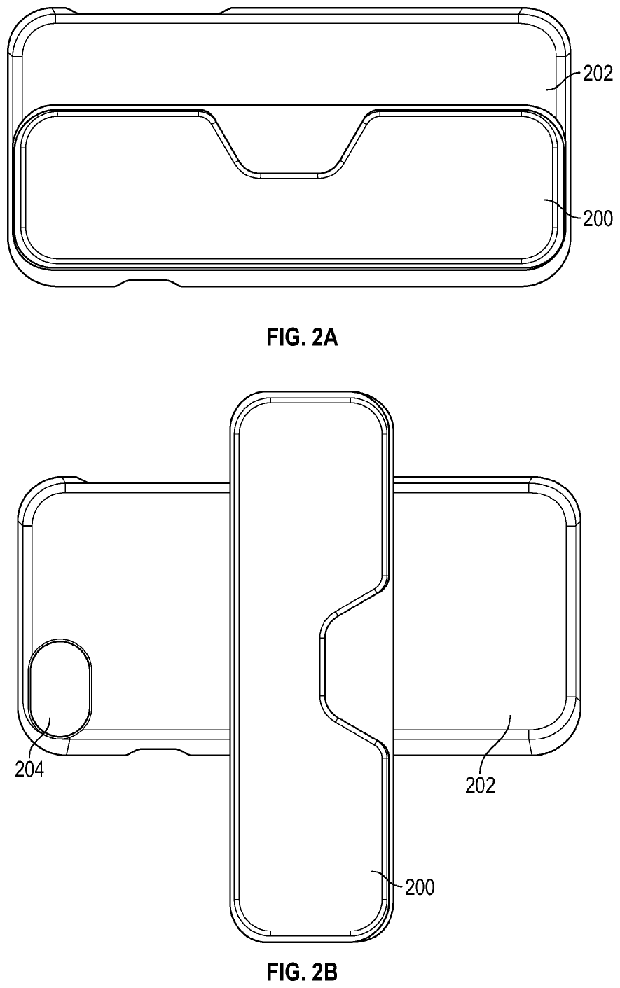

FIGS. 2A and 2B show an embodiment of a case 200 that can be used to hold a pair of eyeglasses (e.g., eyeglasses shown in and described with respect to FIGS. 1A-1E). The case can be configured to be removably attached to a smartphone 202. The connection between the case 200 and the smartphone can allow relative rotation between the case 200 and the smartphone 202. FIG. 2A shows a ‘home carry’ configuration of the case. FIG. 2B shows the case rotated about 90° relative to the smartphone 202 to a ‘camera use’ configuration. As shown in FIG. 2B, rotation of the case 200 exposes the camera 204 of the smartphone 202. The case extending across a mid portion of the phone can also provide for a convenient handle while using the camera function of the phone.

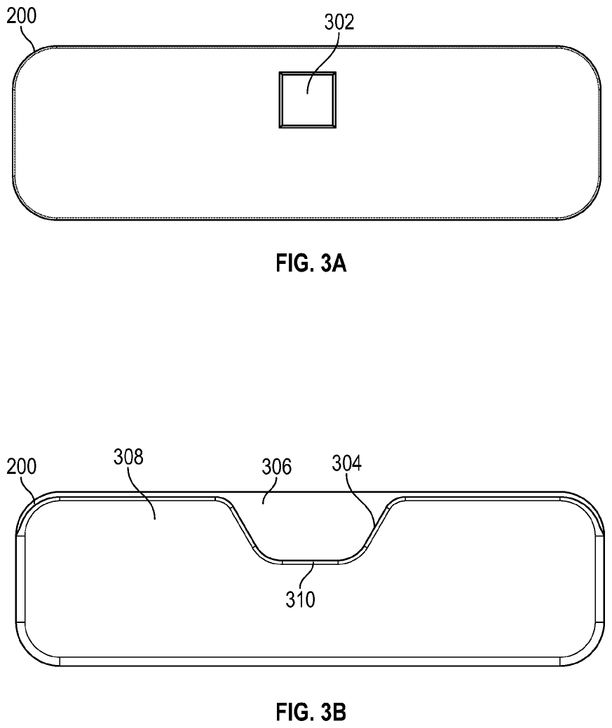

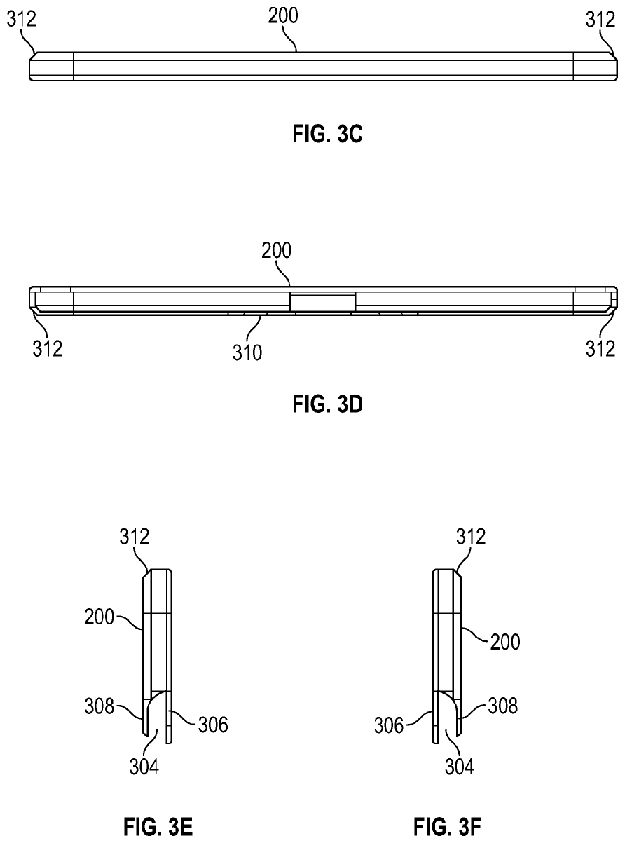

FIGS. 3A-3F show various views of the case 200. FIGS. 3A and 3B show back and front views of the case, respectively. A magnetic connection 302 is visible in the back view of FIG. 3A. In some embodiments, the magnetic connection comprises a square magnet. Other shapes (e.g., circular, rectangular, ovular, etc.) are also possible. The magnet can have a width of about 12-16 mm (or about 12-14 mm, about 12.5-13.5 mm, about 13 mm). The magnet can have a length of about 12-16 mm (or about 12-14 mm, about 12.5-13.5 mm, about 13 mm). The magnet can have a thickness of about 1-3 mm (or about 1.5-2.5 mm, or about 2 mm). In some embodiments, the magnet has dimensions of about 13 mm×13 mm×2 mm. In some embodiments, the magnet has a strength of N52. The magnet can be attached, using, e.g., double sided tape, to any phone and any phone with case. A corresponding case can have a depression 302 shaped to, at least generally, match the size of the magnet attached to the phone. For example, a depression with a size of about 14 mm×14 mm×2 mm can be shaped to receive a magnet with dimensions of about 13 mm×13 mm 2 mm. The depression can comprise a magnetic component (e.g., iron plate) configured to be attracted to or be connected to the magnet attached to the phone. This magnetic connection allows any phone in the market, regardless of the phone's camera size and position, to carry full frame reading glasses, making them portable and always with the user. If a user desires to use the phone camera, the user can detach the case as needed or re-position the glasses case to an angle of 90 degrees by detaching the case, rotating it 90°, and re-connecting the case to the phone in the new position. The case can be attached at any angle, relative to the phone, as long as the depression is shaped to receive the magnet at the desired orientation.

The case 200 is generally rectangular shaped with rounded corners, which can help provide comfort and ease of carrying. A length of the case can be about 137.5 mm (or about 130-145 mm, about 130-140 mm, about 120-145 mm, etc.). A width of the case can be about 41.0 mm (or about 35-45 mm, about 30-50 mm, etc.) As shown in the front view of FIG. 3B, the case comprises a pocket 304 defined by a back wall 306 of the case and a front sleeve 308 providing a front wall and sides to the pocket 304. The height of the back wall can be equal to the width of the case. The height of the sleeve can be about 39.7 mm (or about 35-45 mm, about 30-50 mm, etc.). The sleeve 308 can comprise a height slightly less than the height of the back wall 306. The difference in height can be about 1 mm (or about 1.5 mm, 2 mm, 2.5 mm, etc.). The sleeve 308 can also comprise a cut-out 310 along a top edge of the sleeve 308. The cut-out 310 and difference in height between the back wall and sleeve can help with insertion of glasses into the case. A thickness of the pocket can be about 6.5 mm (or about 6-7 mm, about 5-8 mm, about 4-9 mm, etc.).

FIGS. 3C and 3D show bottom and top views, respectively, of the case 200. As shown in FIGS. 3C and 3D, the length of the case tapers at corners 312 as it moves out from the back wall 306. This taper can provide fewer harsh edges and greater comfort to the case while it is being held or carried in a pocket. The cutout 310 of the sleeve 308 is visible in the top view of FIG. 3D. Both FIGS. 3C and 3D show the slim profile of the case.

FIGS. 3E and 3F show side views of the case 200. The side views show the taper at the corners 312. The side views also show the pocket 304 defined by the back wall 306 and front sleeve 308. The side views also highlight the slim profile of the case 200.

It will be appreciated that other case designs can also be used with the connectors (e.g., magnetic connector) disclosed herein.

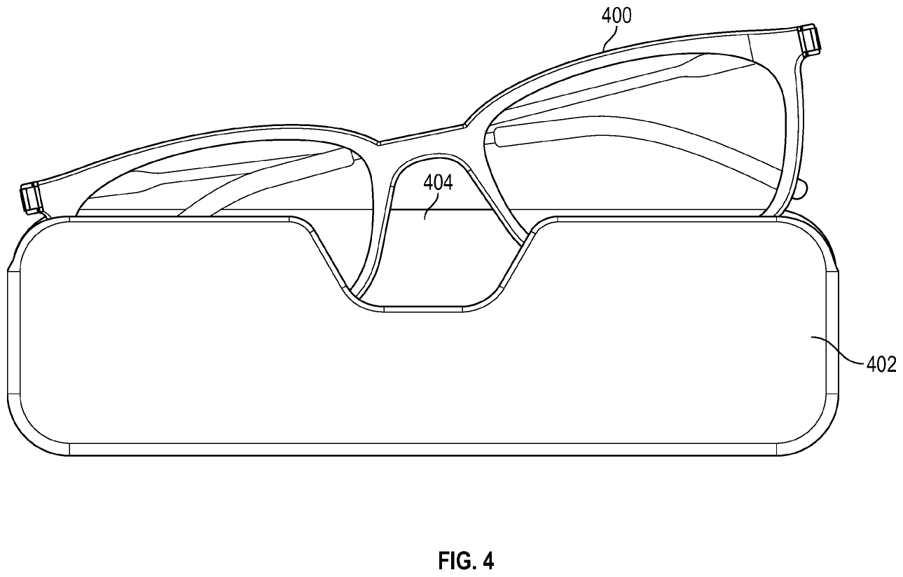

Referring now to FIG. 4, an embodiment of eyeglasses 400 (e g, similar or identical to eyeglasses 100) is shown being tucked into a pocket 404 of a case 402 (e.g., similar or identical to case 200).

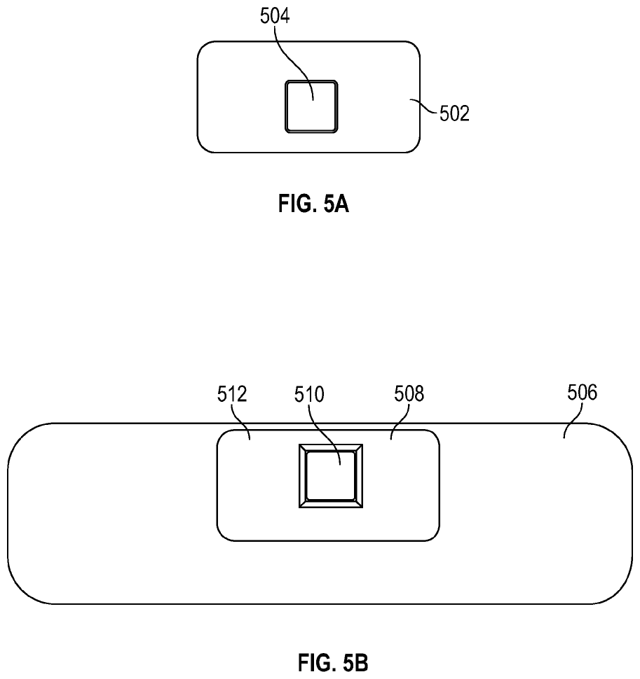

FIGS. 5A and 5B show another embodiment of a method of attachment between a case and another object (e.g., smartphone). FIG. 5A shows an attachment plate 502 configured to be attached to an object (e.g., smartphone). The plate 502 can be attached using, for example, double sided tape. Other attachment mechanisms are also possible (e.g., hook and look attachment). The plate is shown having a rectangular shape with rounded corners, but other shapes are also contemplated (e.g., square, circular, without or without rounded corners, etc.). The rounded corners may help to minimize objects catching on corners of the plate 502. A magnet 504 is attached or connected to the plate.

FIG. 5B shows a back surface of a case 506. The back surface comprises a plate 508 that is configured to attract the magnet 504. In some embodiments, the plate 508 comprises iron. Additional or alternative materials are also possible. The plate 508 comprises a depression 510 shaped to receive the magnet 504. The depression 510 is generally similarly sized and shaped to the magnet 504. The depression 510 can help to offset the thickness of the magnet 504, creating a closer fit between the case 506 and the object and minimizing the overall thickness of the case 506 and the object.

Additionally, the interaction between the depression 510 and the magnet 504 may influence the possible relative orientations between the case 506 and the object (e.g., smartphone). For example, if the magnet 504 is square and the depression is square 510. The case 506 may be rotated to have four different orientations with respect to the object. The case may be positioned at a first position with respect to the object. It can be rotated 90° to a second position. It can be further rotate 90° to a third position, 180° from the original position. The case can be further rotate 90° to a fourth position, 270° from the original position. To change the rotational position of the case, it can be disengaged from the object, rotated to the desired position and then reconnected.

The back surface of the case 506 may comprise a slightly recessed area 512 shaped to mate with the attachment plate 502 on the object (e.g., smartphone). The recessed area 512 can help to offset the thickness of the attachment plate 502, creating a closer fit between the case 506 and the object and minimizing the overall thickness of the case 506 and the object.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. Eyeglasses comprising
a frame comprising a first lens and a second lens connected by a nosebridge;
a first temple piece extending from a first end of the frame and configured to fold down, the first temple piece configured to fold against the frame in a folded configuration;
a second temple piece extending from a second end of the frame, the second temple piece configured to fold flat against the frame in a folded configuration,
wherein the frame is directly connected to the first and second temple pieces without a separately attached hinge.

2. The eyeglasses of claim 1, wherein at least one of the first lens and the second lens is an aspherical lens comprising high index material.

3. The eyeglasses of claim 132, wherein additional lens material is added to an edge of the lens to extend the aspherical lens to the frame.

4. The eyeglasses of any of claims 1-3, wherein the frame comprises a rigid material.

5. The eyeglasses of any of claims 1-4, wherein the thickness of the eyeglasses in the folded configuration is about 2.6 mm.

6. The eyeglasses of any of claims 1-5, wherein at least one of the first lens and the second lens comprises a high index, aspherical lens.

7. The eyeglasses of any of claims 1-6, wherein the frame comprises polycarbonate.

8. The eyeglasses of any of claims 1-7, wherein at least one of the first temple piece and the second temple piece comprises a metal.

9. The eyeglasses of any of claims 1-8, wherein at least one of the first temple piece and the second temple piece comprises nitinol.

10. The eyeglasses of any of claims 1-9, wherein at least one of the first temple piece and the second temple piece is plated or painted to match a color or design of the frame.

11. The eyeglasses of any of claims 1-10, wherein the frame comprises a color or design.

12. The eyeglasses of any of claims 1-11, wherein eyeglasses comprises a loop formed at an end of at least one of the first temple piece and the second temple piece and a pocket formed on an edge of the frame, the loop configured to be inserted into the pocket.

13. The eyeglasses of claim 12, further comprising a pin inserted through the pocket and the loop, the loop configured to rotate about the pin.

14. The eyeglasses of claim 12, further comprising a bearing configured to be inserted within the loop.

15. The eyeglasses of any of claims 1-14, wherein the first and second temple pieces are configured to fold flat against the frame in an unbiased configuration.

16. The eyeglasses of any of claims 1-15, wherein the first and second temple piece comprise a tab comprising an aperture configured to align with an aperture at an end of the frame.

17. The eyeglasses of any of claims 1-16, wherein the first and second temple piece comprise a first tab with a first aperture and a second tab with a second aperture, the first and second apertures configured to align with an aperture at an end of the frame.

18. An eyewear system comprising the eyeglasses of any of claims 1-18 and a case comprising a thickness of less than or equal to about 3.5 mm.

19. A method of manufacturing eyeglasses, comprising
providing a frame comprising a first lens and a second lens connected by a nosebridge;
providing a first temple piece extending from a first end of the frame and configured to fold down, the first temple piece configured to fold against the frame in a folded configuration;
providing a second temple piece extending from a second end of the frame, the second temple piece configured to fold against the frame in a folded configuration;
inserting a first pin within an aperture in the first end of the frame and an opening in the first temple piece, joining the first temple piece to the frame; and
inserting a second pin within an aperture in the second end of the frame and an opening in the second temple piece, joining the second temple piece to the frame, wherein joining the first temple piece and the second temple piece to the frame does not comprise using a separate hinge component.

20. The method of claim 19, further comprising UV printing the frame to apply a color or pattern.

21. The method of claim 19 or 20, further comprising plating at least one of the first and second temple pieces to apply a color or design.

22. The method of any of claims 19-21, further comprising applying soft touch paint to at least one of the first and second temple pieces to apply a color or design.

23. The method of any of claims 19-22, wherein at least one of the lenses is an aspherical lens comprising a high index material.

24. The method of claim 23, wherein providing the frame comprises adding additional material to an edge of the aspherical lens to extend it to reach the frame.

25. The method of claim 23 or 24, wherein providing the frame comprises adding additional material to an edge of the aspherical lens to thicken the edge of the aspherical lens.

26. An eyeglasses case comprising
a back wall;
a front sleeve extending from the back wall, the front sleeve and back wall defining a pocket configured to receive eyeglasses; and
a connector configured to attach the case to a smartphone, wherein the connector is configured to allow connection between the case and the smartphone in a first configuration comprising a first angle between the case and the smartphone and a second configuration comprising a second angle between the case and the smartphone, wherein the first angle is different from the second angle.

27. The eyeglasses case of claim 26, wherein the connector comprises a magnetic connector.

28. The eyeglasses case of claim 26, wherein the connector comprises a depression comprising a magnetic component, the depression configured to receive a magnetic component attached to the smartphone.

29. The eyeglasses case of claim 24 or 25, wherein the connector comprises a depression comprises a magnetic component, the depression shaped to receive a magnetic component attached to the smartphone.

30. The eyeglasses case of claim 29, wherein the depression and the magnetic component comprise a square shape.

31. The eyeglasses case of any of claims 26-30, wherein the first angle and the second angle are generally perpendicular.

32. The eyeglasses case of any of claims 26-31, wherein the connector comprises a plate configured to be attached to the smartphone.

33. The eyeglasses case of claim 32, wherein the case comprises a recessed area shaped to receive the plate.

34. The eyeglasses case of any of claims 26-33, wherein the connector comprises a magnet configured to be attached to the smartphone.

35. An eyeglasses case comprising
a pocket configured to receive eyeglasses; and
a connector configured to attach the case to a smartphone, wherein the connector is configured to allow connection between the case in the smartphone in a first configuration comprising a first angle between the case and the smartphone and a second configuration comprising a second angle between the case and the smartphone, wherein the first angle is different from the second angle.

36. The eyeglasses case of claim 35, wherein the connector comprises a magnetic connector.

37. The eyeglasses case of claim 36, wherein the connector comprises a depression comprising a magnetic component, the depression configured to receive a magnetic component attached to the smartphone.

38. The eyeglasses case of claim 35 or 36, wherein the connector comprises a depression comprises a magnetic component, the depression shaped to receive a magnetic component attached to the smartphone.

39. The eyeglasses case of claim 38, wherein the depression and the magnetic component comprise a square shape.

40. The eyeglasses case of any of claims 35-39, wherein the first angle and the second angle are generally perpendicular.

41. The eyeglasses case of any of claims 35-40, wherein the connector comprises a plate configured to be attached to the smartphone.

42. The eyeglasses case of claim 41, wherein the case comprises a recessed area shaped to receive the plate.

43. The eyeglasses case of any of claims 35-42, wherein the connector comprises a magnet configured to be attached to the smartphone.
